(19) United States
(12) Patent Application Publication
(10) Pub. No.: US 2019/0012307 A1
(43) Pub. Date: Jan. 10, 2019

(54) PROFILE RÉSUMÉ

(71) Applicant: Microsoft Technology Licensing, LLC, Redmond, WA (US)

(72) Inventors: Michelle Ling, San Francisco, CA (US); Tricia Fu, San Francisco, CA (US); Matthew Spencer Rendely, San Francisco, CA (US); Aaron Tyler Rucker, San Francisco, CA (US)

(21) Appl. No.: 15/925,820

(22) Filed: Mar. 20, 2018

Related U.S. Application Data
(60) Provisional application No. 62/529,671, filed on Jul. 7, 2017.

(51) Int. Cl. G06F 17/24; G06Q 10/10; G06Q 50/00; G06F 17/21

(52) U.S. Cl. CPC G06F 17/248; G06Q 10/1053; G06F 17/211; G06F 17/243; G06Q 50/01

(57) ABSTRACT

Discussed in some examples are methods, systems, and machine readable mediums that create custom résumés for a particular context for which the résumé is to be used by utilizing online service data. The context includes the position the user is applying for, a recruiter the user or the company is utilizing, the company that posted the job, the user, and the like. Customizations include organization (e.g., putting more relevant experience first), selection (putting some experience on, but leaving other experiences off, determining what education to highlight, and the like), and inclusion of context-related insights. Context related insights may be short facts or statistics.

### PRIORITY CLAIM

This patent application claims the benefit of priority, under 35 U.S.C. § 119 to U.S. Provisional Patent Application Ser. No. 62/529,671, entitled “PROFILE RÉSUMÉ,” filed on Jul. 7, 2017, which is hereby incorporated by reference herein in its entirety.

### TECHNICAL FIELD

Embodiments pertain to improvements to a user interface by utilizing data to build context sensitive résumés for easily applying to job postings.

### BACKGROUND

Some online services enable users to establish links or connections with persons for the purpose of sharing information with one another. Some online services aim to enable friends and family to communicate and share with one another, while others are specifically directed to users with a goal of facilitating the establishment of professional networks and the sharing of information,

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-5 show illustrations of example résumés produced by the system according to some examples of the present disclosure.

FIG. 6 shows a flowchart of a method for automatically creating a custom résumé according to some examples of the present disclosure.

FIG. 7 is a block diagram showing the functional components of a social networking service according to some examples of the present disclosure.

FIG. 8 is a block diagram illustrating an example of a machine upon which one or more embodiments may be implemented.

### DETAILED DESCRIPTION

One example online service is a social networking service. Many of the examples described herein are provided in the context of a social or business networking website or service. However, the applicability of the inventive subject matter is not limited to a social or business networking service. The present inventive subject matter is generally applicable to a wide range of information and networked services. For example, online job boards where users can view or post résumés and employers can post job openings. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is TWITTER®—a micro-blogging service that allows members to follow other members without explicit permission. Other connection-based social networking services also may allow following-type relationships as well. For example, the social networking service LINKEDIN® allows members to follow particular companies.

Social networking services also feature jobs platforms. For example, employers may post available jobs and members may browse and apply for these jobs. Typically users submit résumés or CVs through a GUI of the social networking service. Résumés or CVs are documents which contain an account of a person's education, qualifications, experience, and interests. These documents are used by employers when evaluating an individual for a job opportunity. Members typically maintain résumés separate from their profiles. Résumés are time consuming to make and update. Moreover, users do not often know which experience and insights are going to be the most valuable to a particular employer. Thus, these résumés are usually a one-size-fits-all document that is submitted as-is to every employer without customization based upon the employer.

As previously noted, social networking services have user profiles that store many of the items that will typically be found in a résumé. Additionally, social networking services have a wealth of information about organizations that post jobs, their employees, and other relevant information. Disclosed in some examples are methods, systems, and machine-readable mediums that automatically create custom résumés for a particular context for which the résumé is to be used by utilizing social networking data. The context includes the position the user is applying for, a recruiter the user or the company is utilizing, the company that posted the job, the user, and the like. Customizations include organization (e.g., putting more relevant experience first), selection (putting some experience on, but leaving other experiences off, determining what education to highlight, and the like), and inclusion of context-related insights. Context related insights may be short facts or statistics and may include social networking relationship data that provides common social connections or relationships between the member and the company that posted the job. Example context-related insights include, the members top skills, top skills best suited for the job, accomplishments, recommendations, a number of connections that the member has, a number of connections that the member has that also work at the company that posted the job, a number of members that have been hired by the company who share a particular characteristic with the member (e.g., same school, common employer in a work history, and the like), a profile completion metric, and the like.

The present disclosure thus provides a technical solution to the problem of maintaining separate member profiles and documents by automatically producing a resume from a member profile on demand. The social networking service created resume also improves on traditional resumes by leveraging social networking service data to optimize the configuration of the resume to increase the changes that the applicant will be noticed and increases the value to job posters by providing relevant and interesting information about job candidates in a clear, and easy to understand format.

As noted, the résumé may be customized based upon the job the member is applying for. For example, the résumé may highlight skills from the member's profile that align with the skills best suited for the job role to demonstrate the member meets minimum requirements to a recruiter or company. As also noted, the system may customize a résumé based on a company or recruiter, such as adding insights like common connections to the company or recruiter and adding information related to that company or recruiter's past history on LinkedIn (e.g., “You've messaged 3 other people at this company in the past”). Similarly, the résumé may be customized based upon the member, for example, differentiating résumés based on position and seniority (internships/entry-level vs. more experienced hires). Other examples include customizing the résumé by adding insights like recommendations or endorsements that other members have written for the member. These recommendations may be from influential people, other employees of the company, or the like. The educational or work experience of the résumé may be customized based upon insights into the company. For example, if a first company has hired over a threshold number of members from a second company, work experience with the second company may be highlighted in an application for a job posting from the first company. In other examples, a particular educational experience may be highlighted or selected for inclusion on the résumé based upon a number or percentage of members who hold the job title of the job posting that also have a similar educational experience.

The generated résumés may be editable by the members as part of one or more Graphical User interfaces (GUIs). All of above examples serve to make generated résumé more relevant and accentuate strengths of the candidate to improve their likelihood of hearing back from a recruiter or employer.

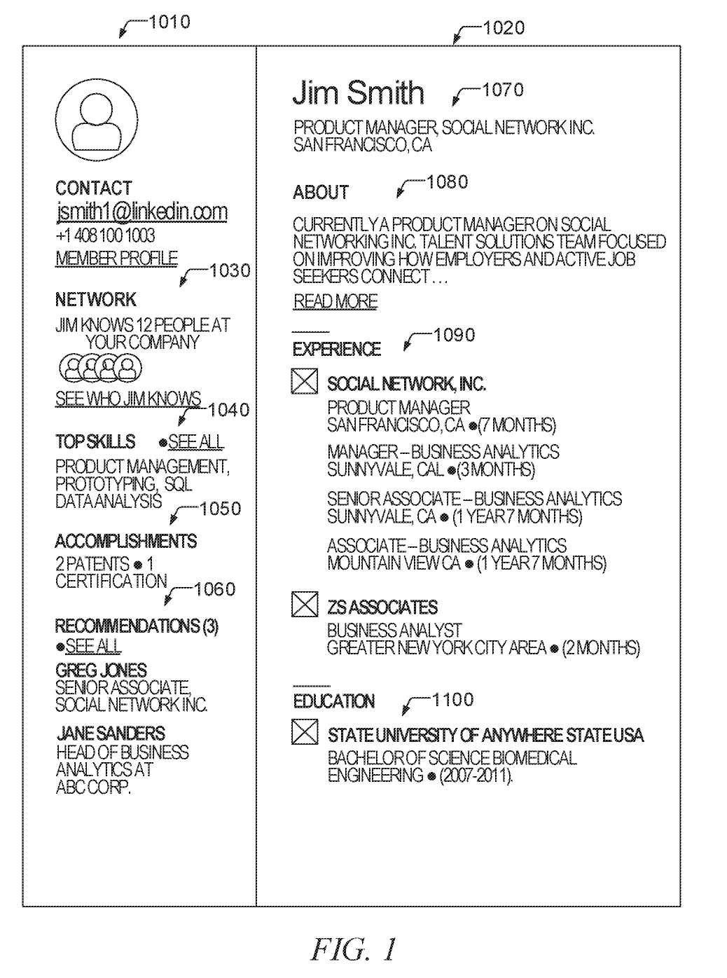

Turning now to FIGS. 1-5, example résumés produced by the system are shown according to some examples of the present disclosure. FIG. 1 shows a column on the left 1010 with a picture, contact information below the picture, a link to a social networking profile of the user. Below the contact information the system shows one or more context related insights. Examples include showing common network members 1030 such as the number of people that this member (e.g., “Jim Smith”) knows at the company to which this résumé is provided. In the case of FIG. 1, Jim knows 12 people at the particular company. This field may be dynamic in that for each particular company that Jim Smith applies to, it will change to reflect the actual number of persons that the member (in this case Jim Smith) knows from that particular company. Below, there is a selectable link that allows a user to view details on the members that Jim knows (“see who Jim knows”). Above the selectable link, thumbnail images of the members that Jim knows may be displayed.

Below the context related insights related to connections of Jim that work at the company, the résumé may comprise a top skills field 1040 that list the top skills possessed by Jim. These may be contextually specific to the job position that the member is applying for. For example, the social networking service may have a predetermined list of skills that correspond to a particular job. Any skills possessed by the member that are on this list may be highlighted in this section.

Next, an accomplishment section 1050 may list accomplishments of the member such as patents, certifications, honors and awards, foreign languages known, publications, and the like. These also may be contextually selected based upon the job the applicant is applying for. For example, the social networking service may have a predetermined list of accomplishments that are desired for a particular job. Any accomplishments of the member that are on this list may be highlighted in this section.

Following this section, the column 1010 may list one or more recommendations from other members of the social networking service 1060. These recommendations may be made by other members who recommend the particular member. For example, Greg Jones and Jane Sanders have recommended Jim Smith. Recommendations may be specific to a particular job position or company. For example, if Jim Smith is applying for a programming job, the recommendations may be selected to be more relevant to the programming job or to the company that the member is applying to. For example, the social networking service may select recommendations from people at the company the member is applying to. In other examples, recommendations may be used by members that have, or have had, the position the member is applying for.

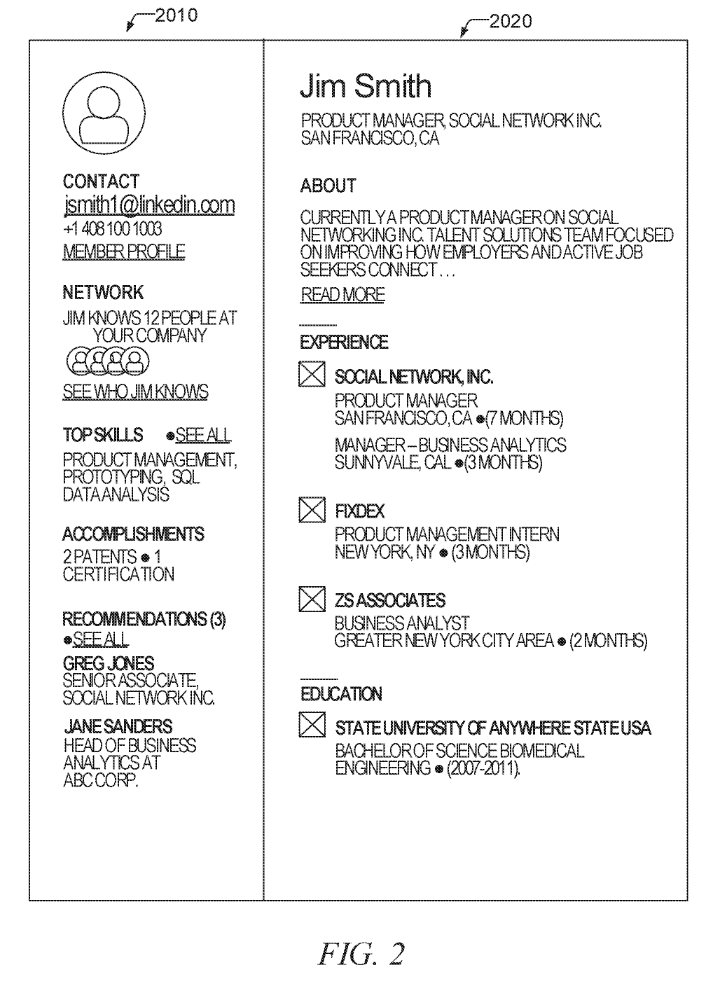

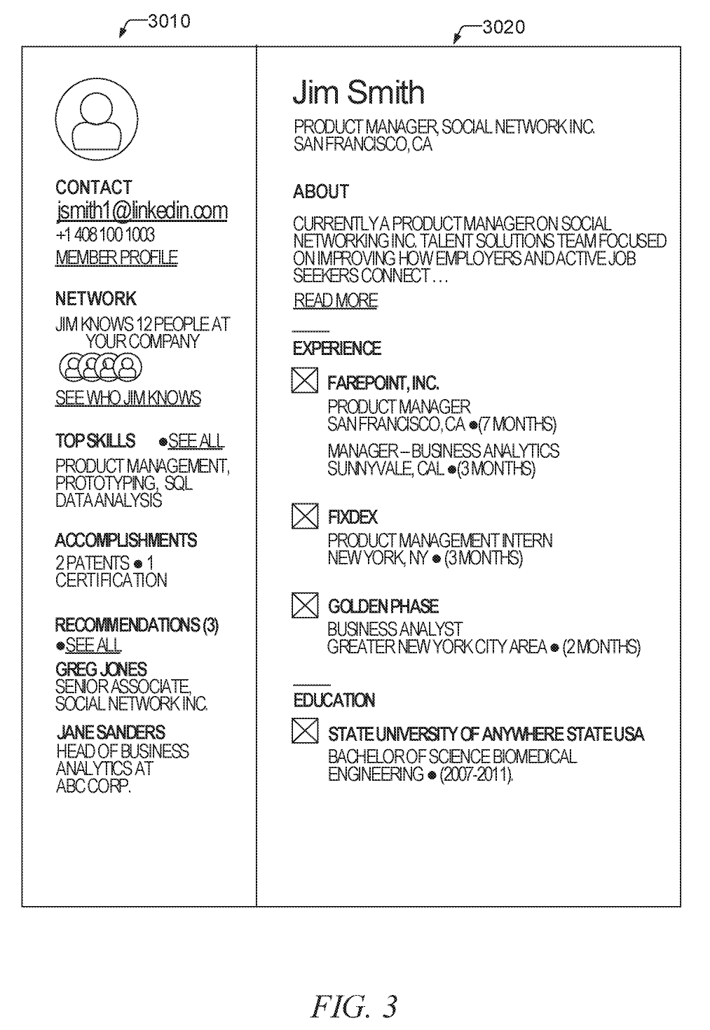

In the main section 1020, the résumé may include a header 1070 including the member's name, current position, and location. A short section titled “About” 1080 gives a brief description written by the member (which may be part of the member profile—such as a summary section). The brief description may be shortened, and a hyperlink may lead viewers to the rest of the text. After this section, the member's experience may be listed in section 1090. In the example of FIG. 1, “Social Network, Inc” and “ZS Associates” are listed. For each experience, a job title, a location, a duration, or other information may be shown. As shown in FIG. 1 (and FIGS. 2 and 3) a logo of each company is shown (shown in the Figure as a square with an X). As shown, member experience at a same organization may be grouped together. After the experience, the member's education is shown in the education section 1100.

As previously described, the selection of items included in the experience section and how those items are ordered may be context dependent. That is, the particular job position the member is applying for may change the selection and ordering of the member's experience. This selection and ordering may be based upon lists stored by the social networking service that describe attributes about jobs identified by their job titles. The social networking service may have lists of relevant skills, related job titles, relevant education, and the like that correspond to those job titles. For example, for a software engineer, relevant skills may be coding, C, Java, and other programming skills. Continuing with the software engineering example, relevant job titles may include programmer, coder, developer, software engineer, product manager, and the like. Relevant education may include computer science, information systems, information theory, and the like.

Relevant experience and education in the member's profile that appear in these lists may be selected for display, or prioritized above other experience or education. For example, if the member has enough relevant (as defined by the lists) experience and education to fill the résumé, the most relevant experience and education may be selected and this relevant experience and education may be sorted based upon a sort schema. One example sort schema may be the traditional résumé ordering of latest-first. Another example sort schema may be based upon a relevance ordering. That is, the lists maintained by the social networking service may also indicate a relative ordering of experience in the list. In other examples, where the member does not have enough relevant (as defined by the lists for the job posting) experience or education to fill the résumé, non-relevant experience or education may be utilized, but listed after the relevant experience or education.

In some examples, experience such as past job positions and the like may be ordered ahead of education experience. In other examples, the ordering of experience and education may be reversed (e.g., education listed first) depending on the quality and breadth of experience vs the quality and breadth of the education. This may highlight a recent graduate's education and downplay the recent graduate's lack of experience. The determination of which comes first may be based upon one or more factors such as: total years experience vs. total years of education; how many years out of school the member is; whether or not the member has any relevant experience at all (if not, then education may be prioritized); and the like. In some examples, these factors may be converted to a numerical value (if they are not already a numerical value), weighted, then summed. The score for the education may be compared to the score for the experience and the section with the highest score may be listed first.

In some examples, the résumé may be based upon a template which may have a number of slots. Slots may be allocated to education, experience, contact information, an about statement, insights (which may be specific insight types), the member's picture, and the like based upon the template. In generating the résumé, the system may fill in the contact information, the about statement, the member's picture and other items from member profile information. Education and experience slots may be filled first by relevant experience and education in order according to the sort schema. Any leftover slots after all relevant education and experience are included may be filled with non-relevant education and experience.

The insights may also be collected based upon social networking service data. Thus, if the template designer had included an insight of “<member name> knows <number> people at your company,” the social networking service would fill in the member name, and the number of connections that member has at the company the member is applying to. Other slots may be filled. as noted e.g., based upon a list of skills important to the particular position the résumé is being prepared for, and the like.

In still other examples, the number of slots that are allocated to education vs. experience may be dynamically adjusted. For example, if a particular member has five relevant educational experiences and 2 relevant work experiences, and the template allocated 3 slots to work experiences and 3 slots to educational experiences, the system may reallocate one of the work experience slots to the educational experience section.

FIG. 2 shows a résumé similar to that of FIG. 1, but with different experience shown. In this case, Fixdex is shown ahead of ZS Associates and fewer positions are shown at Social Network Inc. FIG. 3 continues to shuffle the experience showing Golden Phase instead of ZS Associates. In some examples, FIGS. 1-3 may refer to the same member with the same member profile, but the résumés may be generated for different positions or for different companies. As previously described, even within a particular section (experience, education, and the like) the experience and education may be reshuffled based upon context.

While previously described, the experience and education was selected based upon relevance to the job position, in other examples, the experience and education may be selected based upon relevance to the company that the member is applying to. :For example, the company the member is applying to may hire a lot of people from a particular company and this may make past experience working for this company relevant.

In some examples, both job position and company relevance may be used to select the experience and education. In these examples, the selection may be done using one or more scoring formulas. In some examples, each item of educational and job experience may be scored as to how relevant it is to both the company and the job.

Each educational experience may be scored based upon a company relevance score or a job posting relevance score. For example, educational experience score=company relevance score+job posting relevance score. Similarly, each job experience may be scored based upon a company relevance score or a job posting relevance score. For example, job experience score=company relevance score+job posting relevance score. The job experiences and the educational experiences may be selected based upon the scores (e.g., the highest scoring experiences may be selected). Factors that may be utilized in calculating a score for educational experiences may include the degree attained, the school attended or the like. Factors utilized for calculating a score for a job experience may include the position title, the number of years experience, the company at which the user worked, and the like.

For example, to calculate the company relevance score for educational experiences, the target company may have a matrix of educational experiences and point values. For example, a company may specify that computer science degrees from particular schools may have higher point values than other educational experiences from other schools. In some examples, this matrix may be manually entered by the company, but in other examples, it may be automatically created by the social networking service based upon current employees of the company. Thus if many of the current employees have computer science degrees from Stanford, then both computer science degrees and degrees from Stanford may be ranked higher by being assigned more points.

Similarly, for example, to calculate the job posting score for educational experiences, each job posting may have a matrix of educational experiences and point values. For example, for particular job postings, computer science degrees from particular schools may have higher point values than other educational experiences from other schools. In some examples, this matrix may be manually entered by the social networking service, but in other examples, it may be automatically created by the social networking service based upon current members that hold the position (across the entire social networking service). Thus, if many of the current members that hold the desired position have computer science degrees from Stanford, then both computer science degrees and degrees from Stanford may be ranked higher by being assigned more points.

As an example, to calculate the company relevance score for a job experience, each company may also have a matrix of job experiences and point values. For example, a company may. specify that computer programming positions from particular companies may have higher point values than other educational experiences from other schools. In some examples, this matrix may be manually entered by the company, but in other examples, it may be automatically created by the social networking service based upon current employees of the company. Thus if many of the current employees hold computer programming jobs and they previously worked for certain companies, then both programming jobs and previous experience at the certain companies may be ranked higher by being assigned more points.

As an example, to calculate the job posting relevance score for a job experience, each job posting may have a matrix of jab experiences and point values. For example, for particular job postings, computer programming experiences from particular companies may have higher point values than other experiences from other companies. In some examples, this matrix may be manually entered by the social networking service, but in other examples, it may be automatically created by the social networking service based upon current members that hold the position (across the entire social networking service). Thus, if many of the current members that hold the desired position have computer programming positions and they work for particular companies, then both computer programming jobs and work experiences at the particular companies may be ranked higher by being assigned more points.

Experiences (educational or job) may be weighted (e.g., based upon recency, type of relevance (e.g., whether it is relevant to the job posting, employer, or both), and the like). The top scoring education or experience may then be used to fill those slots on the résumé.

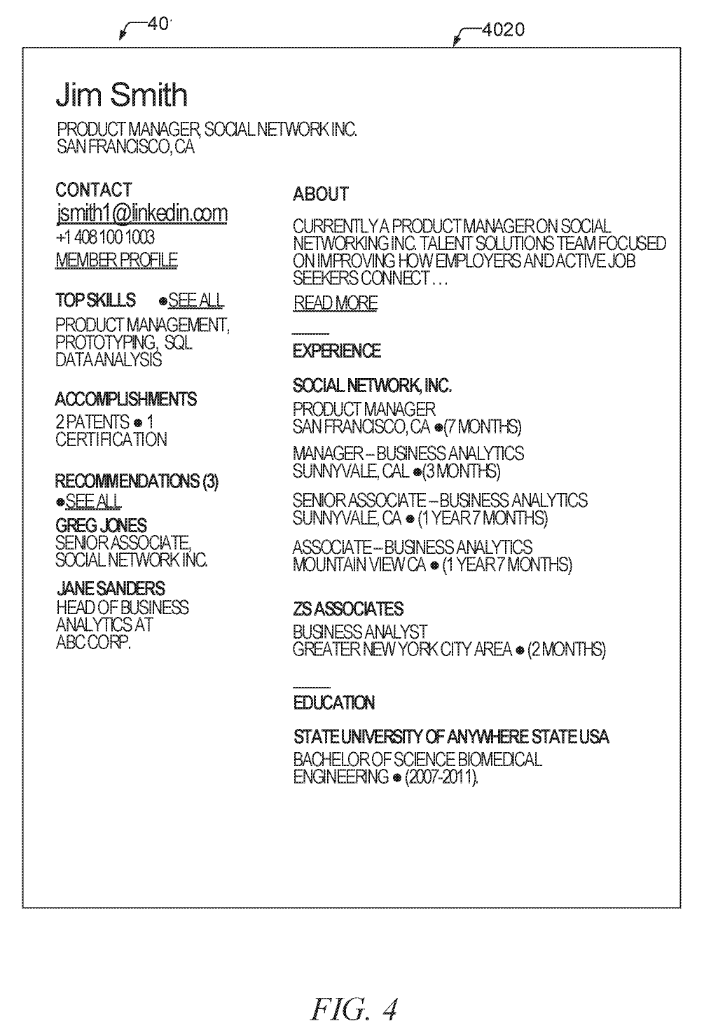

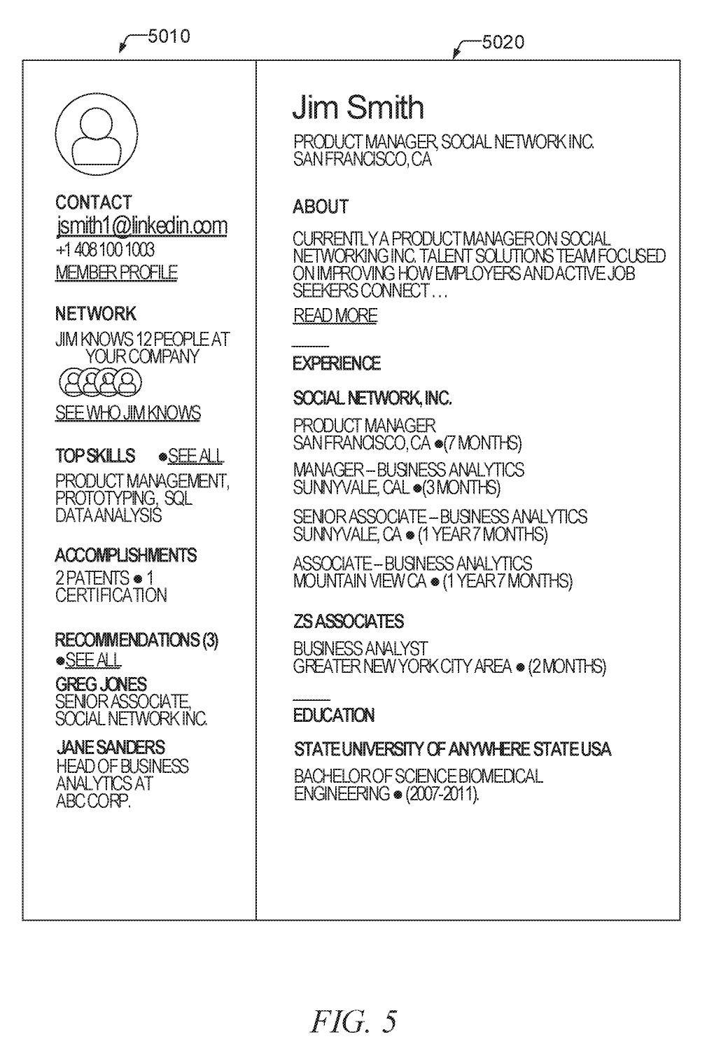

FIG. 4 shows a simple version of the résumé of FIG. 1 without the context-related insight. FIG. 5 shows the résumé of FIG. 1 with a slightly different layout. The company logos for the past experience and the educational institution are not shown. A member, recruiter, or job poster may select one of the templates. For example, a job poster may select a particular template that it wants job applicants to use.

In some examples, a member may cause the social networking service to generate one or more résumés automatically by clicking, selecting, or otherwise activating a Graphical User Interface (GUI) object that indicates an intention to apply for a job (such as a button saying “Apply Now!”). The social networking service may provide a GUI that allows a user to select one or more automatically generated résumés based upon templates that an administrator of the social networking service has defined, or based upon templates the member has previously defined (e.g., the social networking service may provide one or more GUIs for creating templates). The member may be shown a selection of résumés generated based upon these templates in a GUI and may select one to include in the job application that may be transmitted to the company. The templates may be presented in a carousel, a flipbook (e.g., by viewing one résumé at a time with next and previous buttons that cycle through the choices), or other GUI selection. The user may then edit the resume for example, moving one or more sections, and items within sections around, changing the accomplishments, recommendations, top skills, and the like.

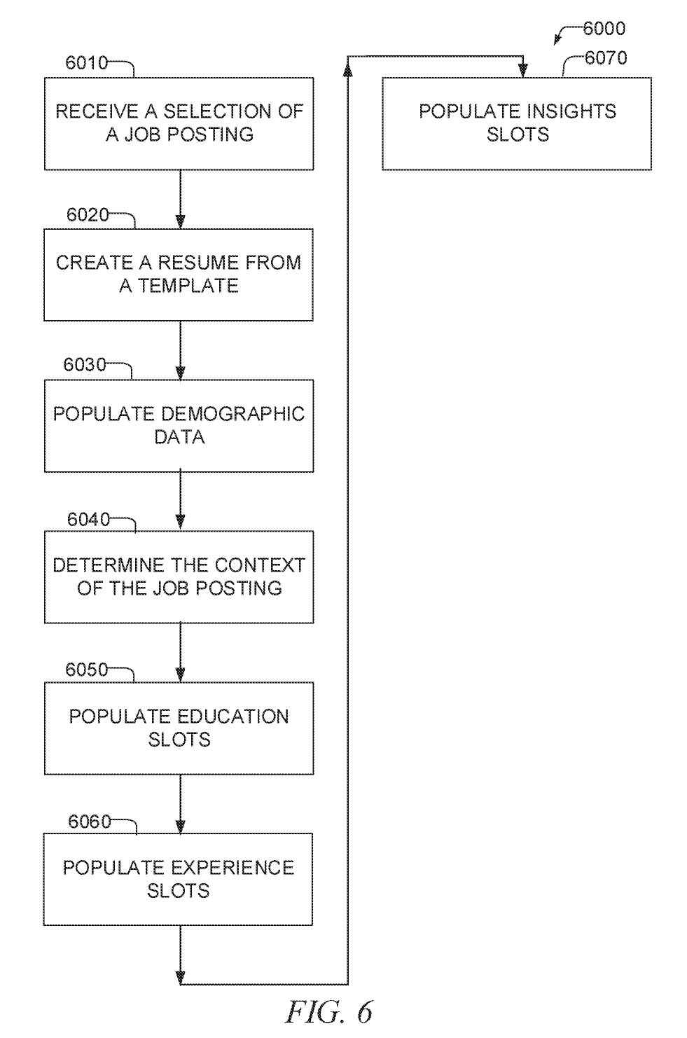

FIG. 6 shows a flowchart of a method 6000 for automatically creating a custom résumé. At operation 6010 a system may receive a selection of a job posting from a member, for example, through a job posting system provided by a social networking service. At operation 6020 a blank résumé may be created from a template. Templates may be HyperText Markup Language (HTML), eXtensible Markup Language (XML), or the like. Templates may specify one or more slots, for example, one or more education slots, demographic data slots, experience slots, insight slots or the like. Slots are portions of the résumé that are filled in by the social networking service and are distinguished from each other by the type of information that the social networking services fills into the slots. For example, education slots are filled with educational information, experience slots are filled in with work history, demographic slots by demographic information (name, contact information, and the like), insight slots by insight information, and the like. Templates may be selected by the user, or may be selected by the company when they post a job posting. In other examples, templates may be automatically selected by the social networking service based upon the job experiences and educational experiences scores. For example, if more educational experiences score higher than job experiences, a resume with more educational experience slots may be selected.

At operation 6030 the system may populate demographic slots with demographic data pulled from the member's profile. Demographic information includes a picture, a name, the member's current position, the member's title, the members address, contact information, grade point average, test scores, field of study, and the like. At operation 6040 the context of the job posting may be determined. The context may include the context of the job (e.g., the job title, job location, and the like), context of the company posting the job (e.g., location, number of employees, company name, industry, other members that report that they work for the company, and the like), context of the member applying (e.g., connections, skills, recommendations, endorsements and the like).

At operation 6050, the education slots may be populated. For each slot for a group of slots), the selected template may have one or more if-then statements or rules that may specify which information to include in the slots based upon the context information. For example if <the education experience> is <in a field related to the job title> then select that educational experience. This instructs the social networking service to select education experiences that are relevant to the job posting. For example, selecting an educational experience of the user having completed a degree in computer science for a computer science related job. As noted, other criteria may be utilized, such as selecting an educational experience based upon the company hiring a lot of employees from a particular school, an educational experience score, and the like. Templates may also specify rules about ordering of the education field.

At operation 6060, the experience slots may be populated. An example template rule for experience may be: if <the job is a software engineering job> then <select experience from software engineering list>. This instructs the social networking service to fill in the experience slots for this job type with any experience with a job of the same type or any type that is in the list of related jobs. Other rules may select particular experiences based upon a number of hires by the company from an employer associated with a particular experience, an experience score, and the like. Templates may also specify rules about ordering of the experience field.

At operation 6070, the insights slots may be populated. The template may specify which insights that are displayed on a particular résumé. For example, “<member name> knows <number of connections> that are employed by <company name>.” The system may determine the blanks by social networking data.

The system may display the résumé and allow members to edit the résumé. The system may also present a number of different résumé options based upon different templates and the member may select which one they prefer. In still other examples, the member may pick a template prior to résumé creation. Templates may be created by an administrator of the social networking service, or by members.

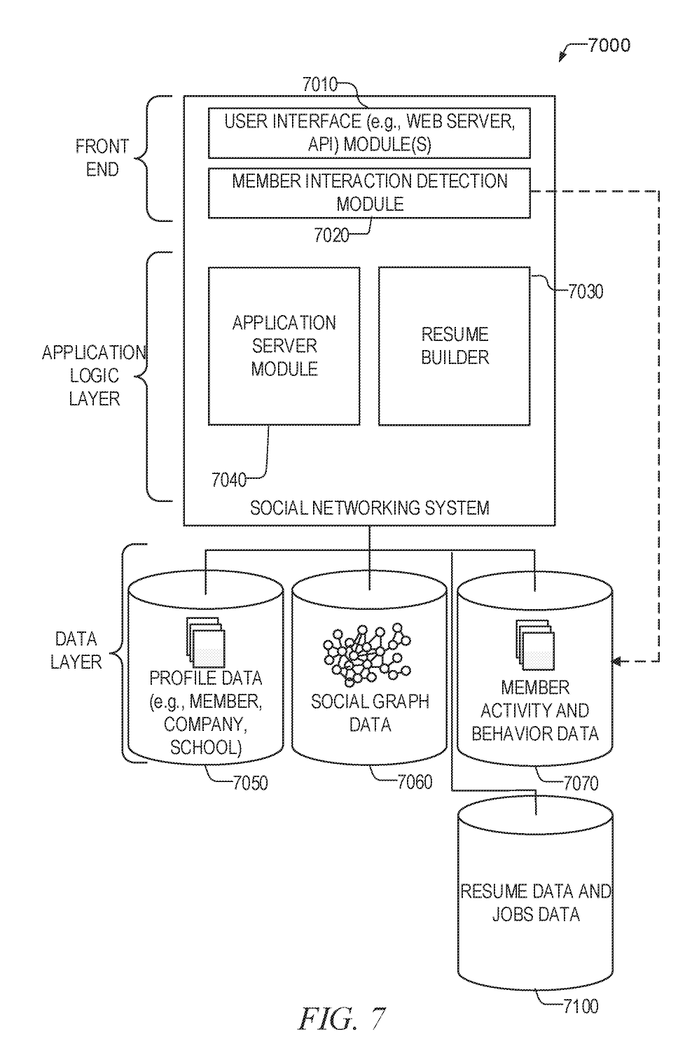

FIG. 7 is a block diagram showing the functional components of a social networking service 7000. As shown in FIG. 7, a front end may comprise a user interface module (e.g., a web server) 7010, which receives requests from various client-computing devices, and communicates appropriate responses to the requesting client devices. For example, the user interface module(s) 7010 may receive requests in the form of Hypertext Transport Protocol (HTTP) requests, or other network-based, application programming interface (API) requests (e.g., from a dedicated social networking service application running on a client device). In addition, a member interaction and detection module 7020 may be provided to detect various interactions that members have with different applications, services and content presented. As shown in FIG. 7, upon detecting a particular interaction, the member interaction and detection module 7020 logs the interaction, including the type of interaction and any meta-data relating to the interaction, in the member activity and behavior database 7070.

An application logic layer may include one or more various application server modules 7040, which, in conjunction with the user interface module(s) 7010, generate various graphical user interfaces (e.g., web pages) with data retrieved from various data sources in the data layer. With some embodiments, application server module 7040 is used to implement the functionality associated with various applications or services provided by the social networking service as discussed above. Application layer may include résumé builder 7030 which may build a résumé as described herein. For example, résumé builder 7030 may implement the method of FIG. 6, and may build résumés such as shown in FIGS. 1-5.

The data layer may include one or more data storage entities or databases such as profile database 7050 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse or family members, educational background (e.g., schools, majors, matriculation or graduation dates, etc.), employment history, skills, professional organizations, and so on. This information is stored, for example, in the profile database 7050. Similarly, when a representative of an organization initially registers the organization with the social networking service, the representative may be prompted to provide certain information about the organization. This information may be stored, for example, in the profile database 7050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 7060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 7 by the member activity and behavior database 7070. Information on job postings, job title information, context information, and résumé templates may be stored in résumé data and jobs data 7100

With some embodiments, the social networking service 7000 provides an application programming interface (API) module with the user interface module 7010 via which applications and services can access various data and services provided or maintained by the social networking service. For example, using an API, an application may be able to request or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

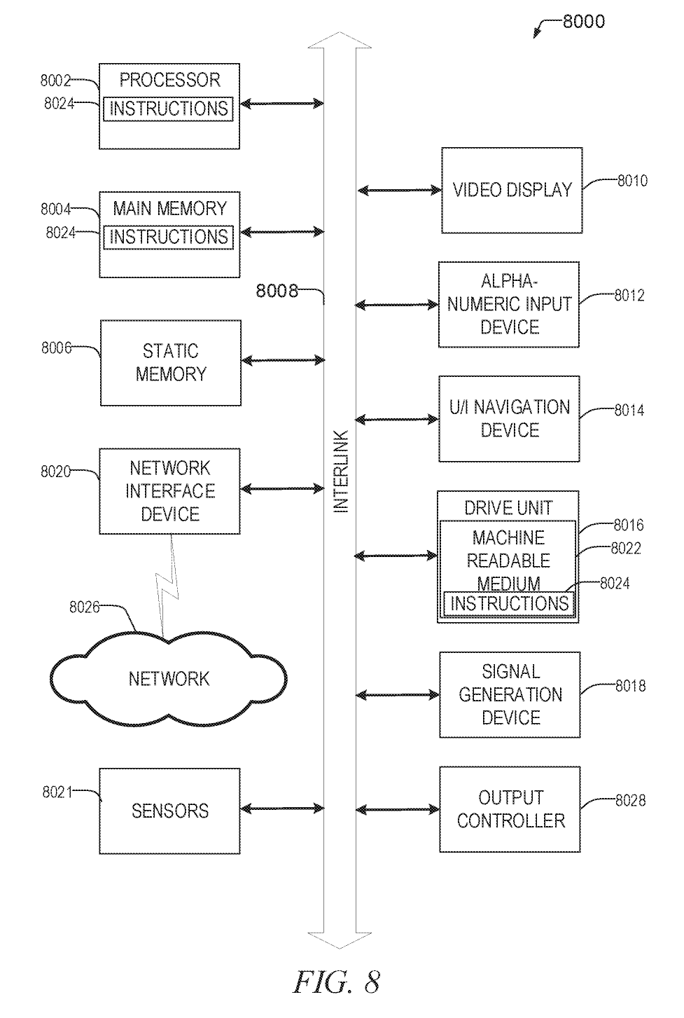

FIG. 8 illustrates a block diagram of an example machine 8000 upon which any one or more of the techniques (e.g., methodologies) discussed herein may perform. In alternative embodiments, the machine 8000 may operate as a standalone device or may be connected (e.g., networked) to other machines. In a networked deployment, the machine 8000 may operate in the capacity of a server machine, a client machine, or both in server-client network environments. In an example, the machine 8000 may act as a peer machine in peer-to-peer (P2P) (or other distributed) network environment. The machine 8000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 8000 may create the résumés of FIGS. 1-5, implement the method of FIG. 6, and the system of FIG. 7. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 8000 may include a hardware processor 8002 (e.g., a central processing unit (CPU), a graphics processing unit (GPU), a hardware processor core, or any combination thereof), a main memory 8004 and a static memory 8006, some or all of which may communicate with each other via an interlink (e.g., bus) 8008. The machine 8000 may further include a display unit 8010, an alphanumeric input device 8012 (e.g., a keyboard), and a user interface (UI) navigation device 8014 (e.g., a mouse). In an example, the display unit 8010, input device 8012 and UI navigation device 8014 may be a touch screen display. The machine 8000 may additionally include a storage device (e.g., drive unit) 8016, a signal generation device 8018 (e.g., a speaker), a network interface device 8020, and one or more sensors 8021, such as a global positioning system (GPS) sensor, compass, accelerometer, or other sensor. The machine 8000 may include an output controller 8028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 8016 may include a machine readable medium 8022 on which is stored one or more sets of data structures or instructions 8024 (e.g., software) embodying or utilized by any one or more of the techniques or functions described herein. The instructions 8024 may also reside, completely or at least partially, within the main memory 8004, within static memory 8006, or within the hardware processor 8002 during execution thereof by the machine 8000. In an example, one or any combination of the hardware processor 8002, the main memory 8004, the static memory 8006, or the storage device 8016 may constitute machine readable media.

While the machine readable medium 8022 is illustrated as a single medium, the term “machine readable medium” may include a single medium or multiple media (e.g., a centralized or distributed database, or associated caches and servers) configured to store the one or more instructions 8024.

The term “machine readable medium” may include any medium that is capable of storing, encoding, or carrying instructions for execution by the machine 8000 and that cause the machine 8000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In sonic examples, machine readable media may include machine readable media that is not a transitory propagating signal.

The instructions 8024 may further be transmitted or received over a communications network 8026 using a transmission medium via the network interface device 8020. The Machine 8000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 8020 may include one or more physical jacks (e.g., Ethernet, coaxial, or phone jacks) or one or more antennas to connect to the communications network 8026. In an example, the network interface device 8020 may include a plurality of antennas to wirelessly communicate using at least one of single-input multiple-output (SIMO), multiple-input multiple-output (MIMO), or multiple-input single-output (MISO) techniques. In some examples, the network interface device 8020 may wirelessly communicate using Multiple User MIMO techniques.

### OTHER NOTES AND EXAMPLES

Example 1 is a method for generating a custom résumé for a member from social networking service data, the method comprising: receiving a selection of a job posting by the member; creating a résumé from a résumé template retrieved from a storage device, the résumé having a plurality of slots for member information specified by the résumé template, the plurality of slots comprising a demographic slot, an education slot, an experience slot, and an insights slot; populating the demographic slot from demographic data of a member profile of the member; determining a context of the job posting; populating the education slot from education data of the member profile based upon the context of the job posting; populating an experience slot from experience data of the member profile based upon the context of the job posting; populating the insights slot based upon the context of the job posting with connectivity data of the member on the social networking service; and communicating the résumé to an organization that posted the job posting.

In Example 2, the subject matter of Example 1 includes, wherein the context of the job posting includes a company that the member is applying to and the connectivity data is a number of connections to members that work at the company.

In Example 3, the subject matter of Examples 1-2 includes, wherein the context of the job posting comprises a job title of a job, and wherein populating an experience slot from experience data of the member profile based upon the context of the job posting comprises selecting one of a plurality of past experiences from the member profile based upon the one of the plurality of experiences being determined to be related to the job title.

In Example 4, the subject matter of Example 3 includes, wherein being determined to be related to the job title comprises the experience corresponding to an experience job title that matches the job title or is on a list of related job titles maintained by the social networking service.

In Example 5, the subject matter of Examples 1-4 includes, wherein the context of the job posting comprises a company name that the member is applying to, and wherein populating an experience slot from experience data of the member profile based upon the context of the job posting comprises selecting one of a plurality of past experiences from the member profile based upon the one of the plurality of past experiences being determined relevant to the company.

In Example 6, the subject matter of Example 5 includes, wherein being determined relevant to the company comprises determining that the company has hired a number of members over a threshold from a second company corresponding to the one of the plurality of past experiences.

In Example 7, the subject matter of Examples 1-6 includes, wherein the context of the job posting comprises a job title of a job, and wherein populating an education slot from education data of the member profile based upon the context of the job posting comprises selecting one of a plurality of educational experiences attended from the member profile based upon the one of the plurality of educational experiences being determined to be related to the job title.

In Example 8, the subject matter of Example 7 includes, wherein being determined to be related to the job title comprises the educational experience corresponding to an educational experience that is on a list of educational experiences related to the job title.

In Example 9, the subject matter of Examples 1-8 includes, wherein the context of the job posting comprises a company the member is applying to, and wherein populating an education slot from education data of the member profile based upon the context of the job posting comprises selecting one of a plurality of educational experiences attended from the member profile based upon the one of the plurality of educational experiences being determined to be related to the company.

In Example 10, the subject matter of Examples 7-9 includes, wherein being determined to be related to the job title comprises determining that the company has hired a number of members over a threshold that also have the selected one of the plurality of educational experiences.

In Example 11, the subject matter of Examples 1-10 includes, presenting, e résumé to the member.

In Example 12, the subject matter of Examples 1-11 includes, creating a second résumé from a second template, and presenting the résumé and the second résumé and one or more graphical user interface controls to allow the user to select a preference between the first and second résumé.

In Example 13, the subject matter of Examples 1-12 includes, submitting the résumé to the company as part of an application for a job corresponding to the job posting.

Example 14 is a machine-readable medium, comprising instructions for generating a custom résumé for a member from social networking service data, the instructions causing a machine to perform operations comprising: receiving a selection of a job posting by the member; creating a résumé from a résumé template retrieved from a storage device, the résumé having a plurality of slots for member information specified by the résumé template, the plurality of slots comprising a demographic slot, an education slot, an experience slot, and an insights slot; populating the demographic slot from demographic data of a member profile of the member; determining a context of the job posting; populating the education slot from education data of the member profile based upon the context of the job posting; populating an experience slot from experience data of the member profile based upon the context of the job posting; populating the insights slot based upon the context of the job posting with connectivity data of the member on the social networking service; service; and service; and communicating the résumé to an organization that posted the job posting.

In Example 15, the subject matter of Example 14 includes, wherein the context of the job posting includes a company that the member is applying to and the connectivity data is a number of connections to members that work at the company.

In Example 16, the subject matter of Examples 14-15 includes, wherein the context of the job posting comprises a job title of a job, and wherein the operations of populating an experience slot from experience data of the member profile based upon the context of the job posting comprises selecting one of a plurality of past experiences from the member profile based upon the one of the plurality of experiences being determined to be related to the job title.

In Example 17, the subject matter of Example 16 includes, wherein being determined to be related to the job title comprises the experience corresponding to an experience job title that matches the job title or is on a list of related job titles maintained by the social networking service.

In Example 18, the subject matter of Examples 14-17 includes, wherein the context of the job posting comprises a company name that the member is applying to, and wherein the operations of populating an experience slot from experience data of the member profile based upon the context of the job posting comprises selecting one of a plurality of past experiences from the member profile based upon the one of the plurality of past experiences being determined relevant to the company.

In Example 19, the subject matter of Example 18 includes, wherein being determined relevant to the company comprises determining that the company has hired a number of members over a threshold from a second company corresponding to the one of the plurality of past experiences.

In Example 20, the subject matter of Examples 14-19 includes, wherein the context of the job posting comprises a job title of a job, and wherein the operations of populating an education slot from education data of the member profile based upon the context of the job posting comprises selecting one of a plurality of educational experiences attended from the member profile based upon the one of the plurality of educational experiences being determined to be related to the job title.

In Example 21, the subject matter of Example 20 includes, wherein being determined to be related to the job title comprises the educational experience corresponding to an educational experience that is on a list of educational experiences related to the job title.

In Example 22, the subject matter of Examples 14-21 includes, wherein the context of the job posting comprises a company the member is applying to, and wherein the operations of populating an education slot from education data of the member profile based upon the context of the job posting comprises selecting one of a plurality of educational experiences attended from the member profile based upon the one of the plurality of educational experiences being determined to be related to the company.

In Example 23, the subject matter of Examples 20-22 includes, wherein being determined to be related to the job title comprises determining that the company has hired a number of members over a threshold that also have the selected one of the plurality of educational experiences.

In Example 24, the subject matter of Examples 14-23 includes, presenting the résumé to the member.

In Example 25, the subject matter of Examples 14-24 includes, wherein the operations further comprise creating a second résumé from a second template, and presenting the résumé and the second résumé and one or more graphical user interface controls to allow the user to select a preference between the first and second résumé.

In Example 26, the subject matter of Examples 14-25 includes, wherein the operations further comprise submitting the résumé to the company as part of an application for a job corresponding to the job posting.

Example 27 is a computing device for generating a custom résumé for a member from social networking service data, the computing device comprising: a hardware processor; a memory, the memory comprising instructions which when executed by the hardware processor cause the computing device to perform operations comprising: receiving a selection of a job posting by the member; creating a résumé from a résumé template retrieved from a storage device, the résumé having a plurality of slots for member information specified by the résumé template, the plurality of slots comprising a demographic slot, an education slot, an experience slot, and an insights slot; populating the demographic slot from demographic data of a member profile of the member; determining a context of the job posting; populating the education slot from education data of the member profile based upon the context of the job posting; populating an experience slot from experience data of the member profile based upon the context of the job posting; populating the insights slot based upon the context of the job posting with connectivity data of the member on the social networking service; and communicating the résumé to an organization that posted the job posting.

In Example 28, the subject matter of Example 27 includes, wherein the context of the job posting includes a company that the member is applying to and the connectivity data is a number of connections to members that work at the company.

In Example 29, the subject matter of Examples 27-28 includes, wherein the context of the job posting comprises a job title of a job, and wherein the operations of populating an experience slot from experience data of the member profile based upon the context of the job posting comprises selecting one of a plurality of past experiences from the member profile based upon the one of the plurality of experiences being determined to be related to the job title.

In Example 30, the subject matter of Example 29 includes, wherein being determined to be related to the job title comprises the experience corresponding to an experience job title that matches the job title or is on a list of related job titles maintained by the social networking service.

In Example 31, the subject matter of Examples 27-30 includes, wherein the context of the job posting comprises a company name that the member is applying to, and wherein the operations of populating an experience slot from experience data of the member profile based upon the context of the job posting comprises selecting one of a plurality of past experiences from the member profile based upon the one of the plurality of past experiences being determined relevant to the company.

In Example 32, the subject matter of Example 31 includes, wherein being determined relevant to the company comprises determining that the company has hired a number of members over a threshold from a second company corresponding to the one of the plurality of past experiences.

In Example 33, the subject matter of Examples 27-32 includes, wherein the context of the job posting comprises a job title of a job, and wherein the operations of populating an education slot from education data of the member profile based upon the context of the job posting comprises selecting one of a plurality of educational experiences attended from the member profile based upon the one of the plurality of educational experiences being determined to be related to the job title.

In Example 34, the subject matter of Example 33 includes, wherein being determined to be related to the job title comprises the educational experience corresponding to an educational experience that is on a list of educational experiences related to the job title.

In Example 35, the subject matter of Examples 27-34 includes, wherein the context of the job posting comprises a company the member is applying to, and wherein the operations of populating an education slot from education data of the member profile based upon the context of the job posting comprises selecting one of a plurality of educational experiences attended from the member profile based upon the one of the plurality of educational experiences being determined to be related to the company.

In Example 36, the subject matter of Examples 33-35 includes, wherein being determined to be related to the job title comprises determining that the company has hired a number of members over a threshold that also have the selected one of the plurality of educational experiences.

In Example 37, the subject matter of Examples 27-36 includes, presenting the résumé to the member.

In Example 38, the subject matter of Examples 27-37 includes, wherein the operations further comprise creating a second résumé from a second template, and presenting the résumé and the second résumé and one or more graphical user interface controls to allow the user to select a preference between the first and second résumé.

In Example 39, the subject matter of Examples 27-38 includes, wherein the operations further comprise submitting the résumé to the company as part of an application for a job corresponding to the job posting.

Example 40 is a computing device for generating a custom résumé for a member from social networking service data, the computing device comprising: means for receiving a selection of a job posting by the member; means for creating a résumé from a résumé template retrieved from a storage device, the résumé having a plurality of slots for member information specified by the résumé template, the plurality of slots comprising a demographic slot, an education slot, an experience slot, and an insights slot; means for populating the demographic slot from demographic data of a member profile of the member; means for determining a context of the job posting; means for populating the education slot from education data of the member profile based upon the context of the job posting; means for populating an experience slot from experience data of the member profile based upon the context of the job posting; means for populating the insights slot based upon the context of the job posting with connectivity data of the member on the social networking service; and communicating the résumé to an organization that posted the job posting.

In Example 41, the subject matter of Example 40 includes, wherein the context of the job posting includes a company that the member is applying to and the connectivity data is a number of connections to members that work at the company.

In Example 42, the subject matter of Examples 40-41 includes, wherein the context of the job posting comprises a job title of a job, and wherein the means for populating an experience slot from experience data of the member profile based upon the context of the job posting comprises means for selecting one of a plurality of past experiences from the member profile based upon the one of the plurality of experiences being determined to be related to the job title.

In Example 43, the subject matter of Example 42 includes, wherein being determined to be related to the job title comprises the experience corresponding to an experience job title that matches the job title or is on a list of related job titles maintained by the social networking service.

In Example 44, the subject matter of Examples 40-43 includes, wherein the context of the job posting comprises a company name that the member is applying to, and wherein the means for populating an experience slot from experience data of the member profile based upon the context of the job posting comprises means for selecting one of a plurality of past experiences from the member profile based upon the one of the plurality of past experiences being determined relevant to the company.

In Example 45, the subject matter of Example 44 includes, wherein being determined relevant to the company comprises determining that the company has hired a number of members over a threshold from a second company corresponding to the one of the plurality of past experiences.

In Example 46, the subject matter of Examples 40-45 includes, wherein the context of the job posting comprises a job title of a job, and wherein the means for populating an education slot from education data of the member profile based upon the context of the job posting comprises means for selecting one of a plurality of educational experiences attended from the member profile based upon the one of the plurality of educational experiences being determined to be related to the job title.

In Example 47, the subject matter of Example 46 includes, wherein being determined to be related to the job title comprises the educational experience corresponding to an educational experience that is on a list of educational experiences related to the job title.

In Example 48, the subject matter of Examples 40-47 includes, wherein the context of the job posting comprises a company the member is applying to, and wherein the means for populating an education slot from education data of the member profile based upon the context of the job posting comprises means for selecting one of a plurality of educational experiences attended from the member profile based upon the one of the plurality of educational experiences being determined to be related to the company.

In Example 49, the subject matter of Examples 46-48 includes, wherein being determined to be related to the job title comprises determining that the company has hired a number of members over a threshold that also have the selected one of the plurality of educational experiences.

In Example 50, the subject matter of Examples 40-49 includes, presenting the résumé to the member.

In Example 51, the subject matter of Examples 40-50 includes, means for creating a second résumé from a second template, and means for presenting the résumé and the second résumé and one or more graphical user interface controls to allow the user to select a preference between the first and second résumé.

In Example 52, the subject matter of Examples 40-51 includes, means for submitting the résumé to the company as part of an application for a job corresponding to the job posting.

Example 53 is at least one machine-readable medium including instructions that, when executed by processing circuitry, cause the processing circuitry to perform operations to implement of any of Examples 1-52.

Example 54 is an apparatus comprising means to implement of any of Examples 1-52.

Example 55 is a system to implement of any of Examples 1-52.

Example 56 is a method to implement of any of Examples 1-52.

What is claimed is:

1. A method for generating a custom résumé for a member from online service data of an online service, the method comprising:
receiving a selection of a job posting by the member;
creating a résumé from a résumé template retrieved from a storage device, the résumé having a plurality of slots for member information specified by the résumé template, the plurality of slots comprising a demographic slot, an education slot, an experience slot, and an insights slot;
populating the demographic slot from demographic data of a member profile of the member;
determining a context of the job posting;
populating the education slot from education data of the member profile based upon the context of the job posting;
populating an experience slot from experience data of the member profile based upon the context of the job posting;
populating the insights slot based upon the context of the job posting with connectivity data of the member with an online service; and
communicating the résumé to an organization that posted the job posting.

2. The method of claim 1, wherein the context of the job posting includes a company that the member is applying to and the connectivity data includes a number of connections to members that work at the company.

3. The method of claim 1, wherein the context of the job posting comprises a job title of a job, and wherein populating the experience slot from experience data of the member profile based upon the context of the job posting comprises selecting one of a plurality of past experiences from the member profile based upon the one of the plurality of experiences being determined to be related to the job title.

4. The method of claim 3, wherein being determined to be related to the job title comprises the experience corresponding to an experience job title that matches the job title or is on a list of related job titles maintained by the social networking service.

5. The method of claim 1, wherein the context of the job posting comprises a company name that the member is applying to, and wherein populating an experience slot from experience data of the member profile based upon the context of the job posting comprises selecting one of a plurality of past experiences from the member profile based upon the one of the plurality of past experiences being determined relevant to the company.

6. The method of claim 5, wherein being determined relevant to the company comprises determining that the company has hired a number of members over a threshold from a second company corresponding to the one of the plurality of past experiences.

7. The method of claim 1, wherein the context of the job posting comprises a job title of a job, and wherein populating an education slot from education data of the member profile based upon the context of the job posting comprises selecting one of a plurality of educational experiences attended from the member profile based upon the one of the plurality of educational experiences being determined to be related to the job title.

8. The method of claim 7, wherein being determined to be related to the job title comprises the educational experience corresponding to an educational experience that is on a list of educational experiences related to the job title.

9. The method of claim 1, wherein the context of the job posting comprises a company the member is applying to, and wherein populating an education slot from education data of the member profile based upon the context of the job posting comprises selecting one of a plurality of educational experiences attended from the member profile based upon the one of the plurality of educational experiences being determined to be related to the company.

10. The method of claim 7, wherein being determined to be related to the job title comprises determining that the company has hired a number of members over a threshold that also have the selected one of the plurality of educational experiences.

11. The method of claim 1, further comprising, presenting the résumé to the number.

12. The method of claim 1, further comprising, creating a second résumé from a second template, and presenting the résumé and the second résumé and one or more graphical user interface controls to allow the user to select a preference between the first and second résumé.

13. The method of claim 1, further comprising submitting the résumé to the company as part of an application for a job corresponding to the job posting.

14. A machine-readable medium, comprising instructions for generating a custom résumé for a member from social networking service data, the instructions causing a machine to perform operations comprising:
receiving a selection of a job posting by the member;
creating a résumé from a résumé template retrieved from a storage device, the résumé having a plurality of slots for member information specified by the résumé template, the plurality of slots comprising a demographic slot, an education slot, an experience slot, and an insights slot;
populating the demographic slot from demographic data of a member profile of the member;
determining a context of the job posting;
populating the education slot from education data of the member profile based upon the context of the job posting;
populating an experience slot from experience data of the member profile based upon the context of the job posting;
populating the insights slot based upon the context of the job posting with connectivity data of the member on the social networking service; and
communicating the résumé to an organization that posted the job posting.

15. The machine-readable medium of claim 14, wherein the context of the job posting includes a company that the member is applying to and the connectivity data is a number of connections to members that work at the company.

16. The machine-readable medium of claim 14, wherein the context of the job posting comprises a job title of a job, and wherein the operations of populating an experience slot from experience data of the member profile based upon the context of the job posting comprises selecting one of a plurality of past experiences from the member profile based upon the one of the plurality of experiences being determined to be related to the job title.

17. The machine-readable medium of claim 16, wherein being determined to be related to the job title comprises the experience corresponding to an experience job title that matches the job title or is on a list of related job titles maintained by the social networking service.

18. The machine-readable medium of claim 14, wherein the context of the job posting comprises a company name that the member is applying to, and wherein the operations of populating an experience slot from experience data of the member profile based upon the context of the job posting comprises selecting one of a plurality of past experiences from the member profile based upon the one of the plurality of past experiences being determined relevant to the company.

19. The machine-readable medium of claim 18, wherein being determined relevant to the company comprises determining that the company has hired a number of members over a threshold from a second company corresponding to the one of the plurality of past experiences.

20. The machine-readable medium of claim 14, wherein the context of the job posting comprises a job title of a job, and wherein the operations of populating an education slot from education data of the member profile based upon the context of the job posting comprises selecting one of a plurality of educational experiences attended from the member profile based upon the one of the plurality of educational experiences being determined to be related to the job title.
